(19) United States
(12) Patent Application Publication
(10) Pub. No.: US 2008/0023868 A1
(43) Pub. Date: Jan. 31, 2008

(54) Bamboo beam and process

(75) Inventors: Leland Slaven, Bradenton, FL (US); Morton A. Siegler, Sarasota, FL (US)

Correspondence Address: CHARLES J. PRESCOTT, P.A., SUITE 115, 2033 WOOD STREET, SARASOTA, FL, 34237, US

(73) Assignees: Madison Insurance Trust, Longboat Key, FL (US); Newcore, L.P., Longboat Key, FL (US)

(21) Appl. No.: 11/707,205

(22) Filed: Feb. 13, 2007

Related U.S. Application Data
(63) Continuation-in-part of application No. 11/494,113, filed on Jul. 27, 2006.

(51) Int. Cl. B27N 3/00

(52) U.S. Cl. 264/109; 428/292.4

(57) ABSTRACT

Bamboo building material and process of manufacture therefor. The material includes a plurality of layers each formed of bamboo segments which have been dried and glue coated. The segments are substantially free of outer nodes and husk and inner membrane material prior to application of glue. The longitudinal axes of the segments in each layer are generally parallel to one another, each layer having segments oriented generally orthogonally with respect to the next adjacent layers thereto. The layers of segments being compressed and bonded together until the glue cures into a single integral structure.

### CROSS-REFERENCE TO RELATED APPLICATIONS

This application is a continuation-in-part of U.S. application Ser. No. 11/494,113 filed Jul. 27, 2006.

### STATEMENT REGARDING FEDERALLY SPONSORED RESEARCH OR DEVELOPMENT

Not applicable

### INCORPORATION-BY-REFERENCE OF MATERIAL SUBMITTED ON A COMPACT DISC

Not applicable

### BACKGROUND OF THE INVENTION

1. Field of the Invention

This invention relates generally to structural wood substitutes, and more particularly to a bamboo beam and process for making same from stranded bamboo segments stripped of all epidermis material and formed into multiple cross oriented layers and bonded under high pressure and temperature into a solid bamboo beam product.

2. Description of Related Art

Because we have, as a world community, substantially depleted the original tree growth in our forests with which we were blessed, manufacturers of wood products utilized in the construction industry have had to resort to next-generation tree growth which, in many cases, produces substantially less wood product as they are necessarily cut down well short of full maturity in size.

Composite lumber formed of wood products such as oriented strand board (OSB) as is described in the SBA Structural Board Association U.S. Edition 2005 Manual, has become a popular substitute for solid wood products. By utilizing substantially all of the wood growth of next-generation forests as facilitated by the OSB process, a very substantial composite wood-based product rivaling the strength of solid wood beams is achievable.

Because of its strength and rapid re-growth cycle, another alternative is to turn to bamboo composite products utilized to form composite wood replacement or alternative beam, plywood and structural products. One particularly interesting bamboo wood replacement product is disclosed in Plaehn, in U.S. Pat. No. 5,543,197. This disclosure teaches a composite bamboo beam which includes segments of bamboo stalk, either split or whole, which are longitudinally aligned and randomly stacked and then compressed and bonded together to form a cohesive bamboo composite structure from which beams of a desired dimension may be cut. Strength consistency is lacking in this bamboo product, however.

The present invention also utilizes bamboo segments in a unique way to develop an even stronger bamboo beam structure for use in the building industry. The process of compressing and final beam formation is taught by Trautner in U.S. Pat. No. 3,723,230, the teaching of which is incorporated herein by reference. Trautner teaches a continuous press for pressing glue-coated consolidatable press charges into structural composite wood structural components.

The significant aspect of the present invention is the recognition that bamboo segments may only be securely glued into a cohesive bamboo composite structure after the outer epidermis surface material and nodes have been machined, abraded or otherwise stripped therefrom. Current glue technology is somewhat inadequate in its binding effect with a bamboo surface which still retains any portion of the epidermis husk or inner membrane material prior to the drying and bonding of the bamboo segments as will be more described more completely herebelow.

### BRIEF SUMMARY OF THE INVENTION

This invention is directed to a bamboo building material and process of manufacture therefor. The material includes a plurality of layers each formed of bamboo segments which have been dried and glue coated. The segments are substantially free of outer nodes and husk and inner membrane material prior to application of glue. The longitudinal axes of the segments in each layer are generally parallel to one another, each layer having segments which may be generally parallel or oriented generally orthogonally with respect to the next adjacent layers thereto. The layers of segments being compressed and bonded together until the glue cures into a single integral structure and with improved physical properties.

It is therefore an object of this invention to provide a composite bamboo structure and beams for use in the building industry as a substitute for solid wood or composite wood products.

It is another object of this invention to provide a composite bamboo beam structure having higher strength ratios than those previously attained.

Still another object of this invention is to provide a multi-layer composite bamboo beam incorporating existing OSB manufacturing technology to produce superior bamboo beam products.

And another object of this invention is to provide composite beam products formed of bamboo segments in multi-layer arrays which clearly exhibits superior glue-to-bamboo segment adhesion by the prior removal of substantially all epidermis materials from the bamboo segments.

In accordance with these and other objects which will become apparent hereinafter, the instant invention will now be described with reference to the accompanying drawings.

### BRIEF DESCRIPTION OF THE SEVERAL VIEWS OF THE DRAWING(S)

FIG. 1 is a perspective view a portion of the main stalk or culm of bamboo.

FIG. 2 depicts the longitudinal segmenting of each bamboo stalk.

FIG. 3 depicts each of the longitudinally segmented portions of the stalk of FIG. 2.

FIG. 4 depicts the step of removing nodes and epidermis material from both inner and outer surfaces, flattening and dewatering of each stalk segment of FIG. 3 into slats.

FIG. 5 is a simplified perspective view of one method of stranding process of each of the bamboo slats from FIG. 4 into bamboo segments.

FIG. 6 is a perspective view of the bamboo segments being initially treated for insect and parasite removal.

FIG. 7 is a perspective view of the bamboo segment drying process.

FIG. 8 is a perspective view of the blending and coating of the dried bamboo segments with a suitable adhesive.

FIG. 9 shows the orienting and layering of bamboo segments into a composite multi-layer bamboo mat ready for final compressing and bonding into a bamboo structure.

FIG. 10 is a perspective view of the final step of transforming the bamboo multi-layer mat of FIG. 9 into the bamboo structure.

FIG. 11 is a perspective view showing the cutting of the finished bamboo structure into desired sizes.

FIG. 12 is a perspective view of a preferred process of splitting a length of bamboo stalk into halves.

FIG. 13 is a perspective view depicting the flattening, dewatering and partial segmenting of each bamboo stalk half produced in FIG. 12.

FIG. 14 depicts the preferred process of stranding each of the bamboo slats produced in FIG. 13.

FIG. 15 is a pictorial view depicting the layering of the bamboo segments into a rigid support frame in preparation for final compressing and bonding of the segments into a bamboo structure.

FIG. 16 is an end view of a bamboo structure made in accordance with the present invention (with defect) in comparison to a conventional southern pine timber.

FIG. 17 shows top plan views of the bamboo and conventional timber of FIG. 16.

FIG. 18 is an enlarged end perspective view of the bamboo structure of FIG. 16 after nailing plate penetration thereinto.

FIG. 19 is an enlarged end view of FIG. 18.

### DETAILED DESCRIPTION OF THE INVENTION

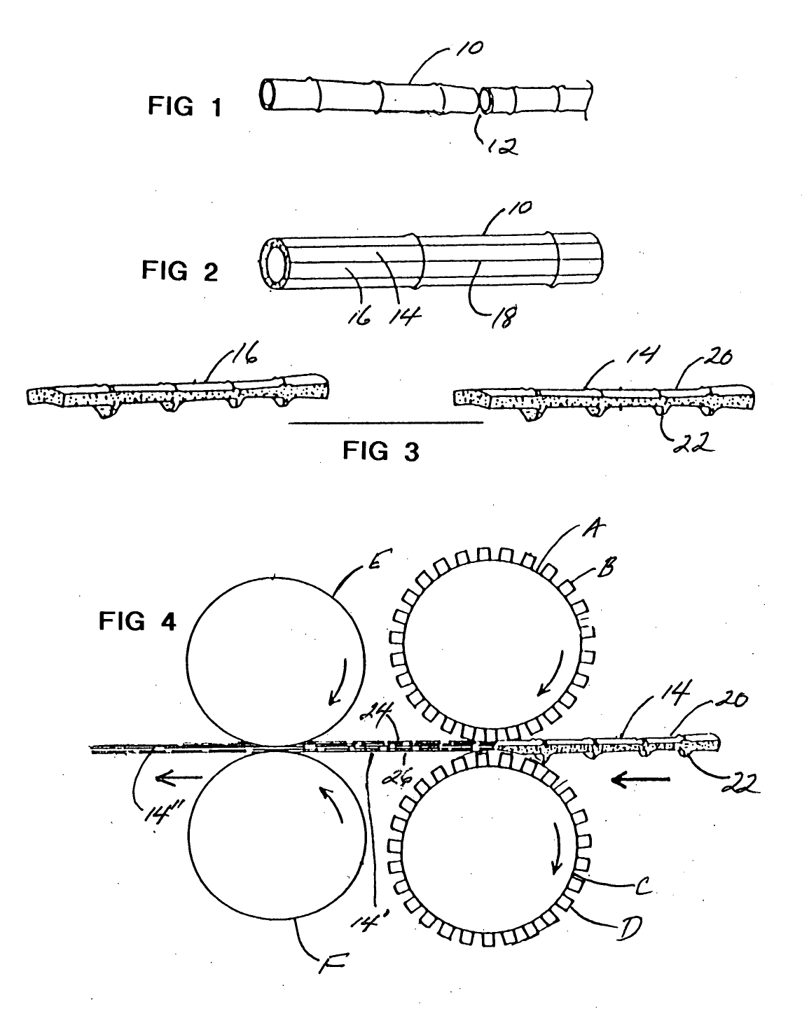

Referring now to the drawings, and particularly to FIGS. 1 to 4, a portion of a bamboo stalk is shown at numeral 10 in FIG. 1 cut into segments at 12 for further processing. In FIG. 2, each of the bamboo stalks 10 are shown longitudinally segmented by radial inward cuts at 18 to form bamboo slats 14 and 16 as seen in FIG. 3. These longitudinal bamboo slats 14 and 16 have exterior epidermis material on the exterior and interior surfaces 20 and 22, respectively, including nodes on the inner surface 22 which must be removed in accordance with the present invention for achieving consistent superior bond adhesion for strength as described herebelow.

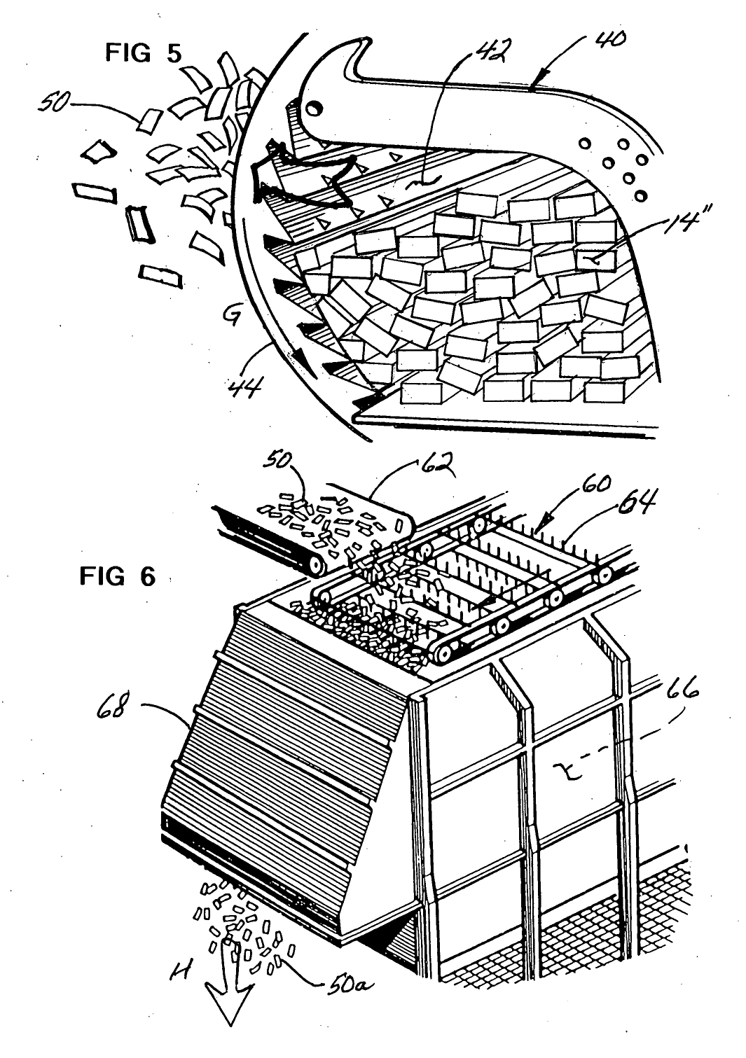

In FIG. 4, each of the bamboo slats 14 are fed through a pair of abrasion or machining wheels A and C, each of which have radially extending machining tips B and D which rotate in the direction of the arrows to remove all of the green epidermis material from the outer and inner surfaces 20 and 22, including the nodes. The first modified bamboo slats 14′, now having stripped outer and inner surfaces 24 and 26 then move on a continuous basis through rollers E and F which compress and flatten and dewater the bamboo slats at 14″ ready for further processing. This equipment, commercially called a veneer slicer, is available from Marunaka and Industrial Machinery Sales of Medford, Oreg.

With a substantial portion of the moisture having been extracted as shown in FIG. 4, the twice-modified bamboo slats 14″ are loaded as shown in FIG. 5 into a stranding machine 40 which includes a stranding drum 44 with blades 42 inwardly disposed and which rotates in the direction of arrow G. The stranded bamboo segments shown generally at 50 preferably having a size range of about 0.015″-0.030″ in thickness, 1″-2″ in width, and 6″-12″ (or longer) in length discharge from the stranding apparatus 40 and are ready for an initial chemical processing as seen in FIG. 6. The bamboo segments 50 are fed by conveyor 62 of apparatus 60 onto a sorting conveyor 64 and chemically treated within the interior chamber 66 to remove all insects and parasites for discharge at 68 in the direction of arrow H, the treated segments being shown generally at 50a. Note that apparatus 60 may accomplish this step by boiling, steam or chemicals.

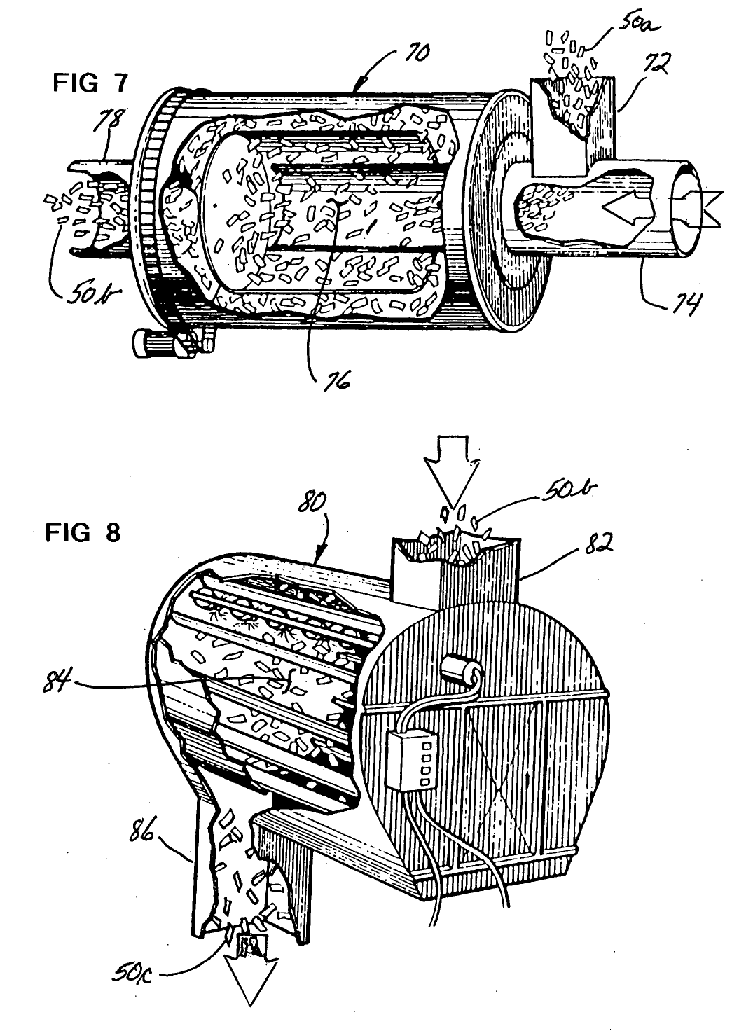

In FIG. 7, a continuous drying apparatus 70 receives the bamboo segments 50a into inlet chute 72, heated air being forced into the drying apparatus 70 through inlet 74. Both heated air and bamboo segments 50a mix and tumble within the chamber 76 to effect complete moisture drying of the bamboo segments for discharge at 78 in the form of dried bamboo segments 50b.

In FIG. 8, a glue-applying apparatus 80 receives the dried bamboo segments 50b into chute 82. The inner chamber 84 tumbles the bamboo segments 50b while a layer or coating of suitable glue is applied over substantially all of the exterior surfaces of the bamboo segments 50b. These glue-coated bamboo segments 50c are discharged downwardly in the direction of the arrow from discharge chute 86. The preferred glue coating is available from Black brothers in North Carolina.

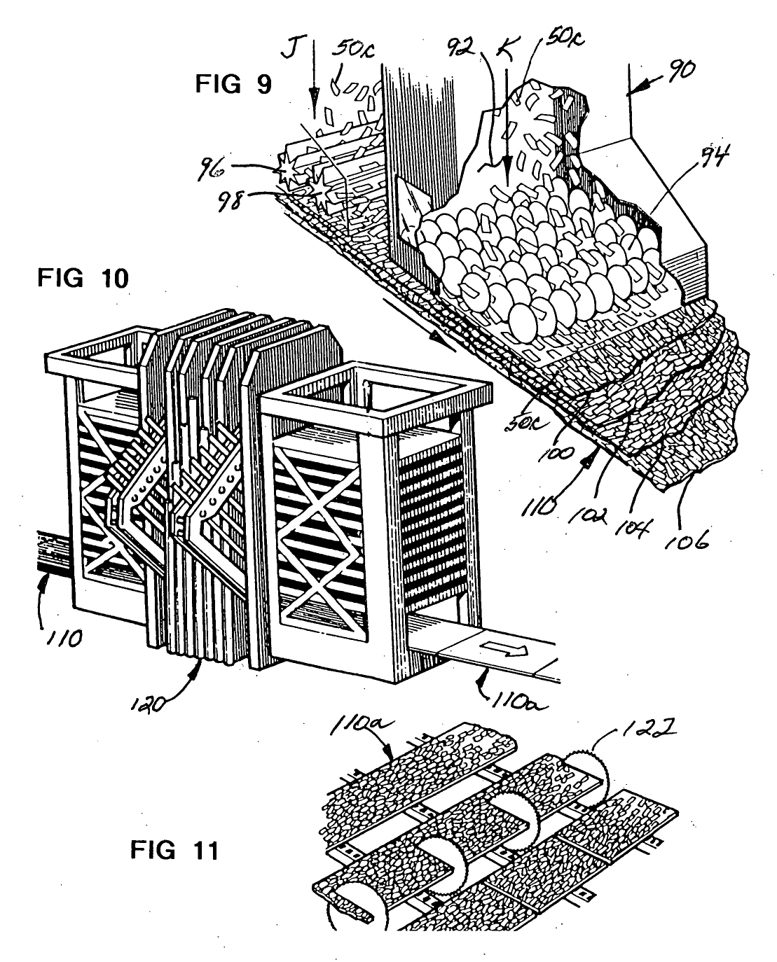

In FIG. 9, the bamboo segments 50c are dispensed by gravity in the direction of arrows J and K into two different portions of a mat-forming apparatus 90. The mat, shown generally at numeral 110, includes multiple layers 100, 102, 104 and 106 of bamboo segments 50c which are cross or orthogonally oriented one to another for added strength in the final product. Rollers 96 and 98 orient the bamboo segments 50c in a transverse orientation while those bamboo segments 50c being dispensed by gravity through chamber 92 onto longitudinally aligned rollers 94 align the bamboo segments 50c in the longitudinal direction of the mat 110. Each of the layers 100, 102, 104 and 106 generally have a thickness in the range of about 0.03″-0.06″. This equipment, called a Layup Forming Lines machine is available from Dieffenbacher GmbH & Co. KG of Germany.

The assembled mat 110 is then fed into a compressing apparatus 120 similar to that described in U.S. Pat. No. 3,723,230 previously incorporated by reference. This compression apparatus 12 applies high pressure in the range of about 200 p.s.i. and optionally heat, depending on the particular adhesive coating utilized, to fully cure the adhesive and convert the mat 110 into a structurally finished product 110a which, in FIG. 11, is then fed into gang saw cutting wheels 122 for proper sizing prior to shipment. Note that the inclusion of heat facilitates the use of a lesser expensive adhesive to achieve a desired consistent superior strength level.

By this process, a very homogeneous bamboo structural product or beam is produced, which has exhibited substantially higher strength ratios than previously achieved by other composite bamboo wood substitute products for the construction industry. A key aspect of this invention and enhanced strength consistency is achieved through the removal of all of the epidermis material from the bamboo stalk segments prior to further processing as above described.

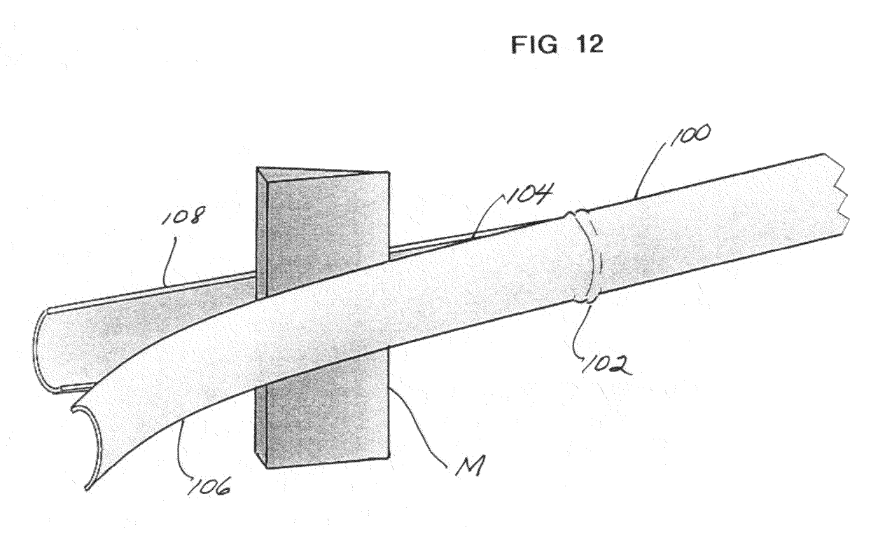

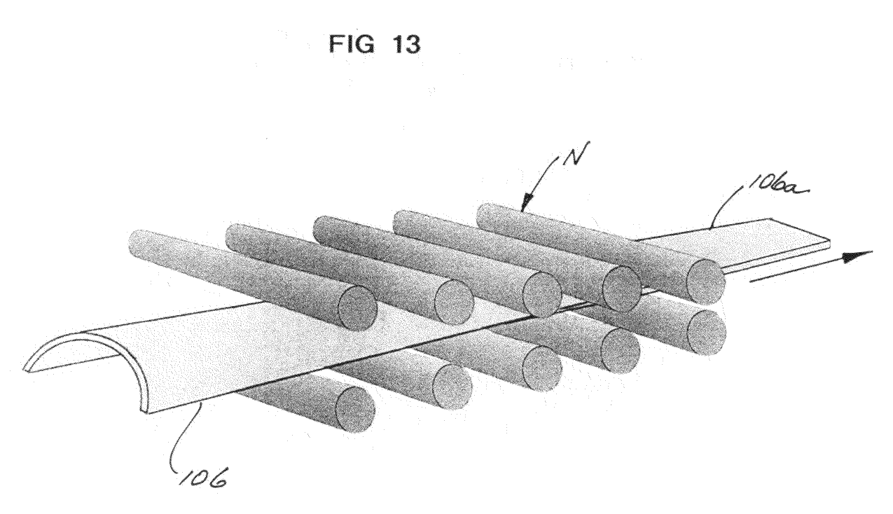

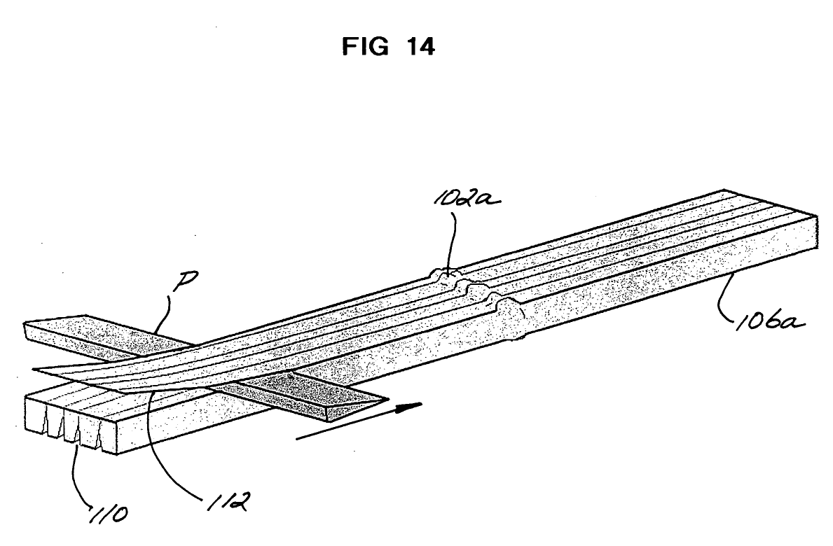

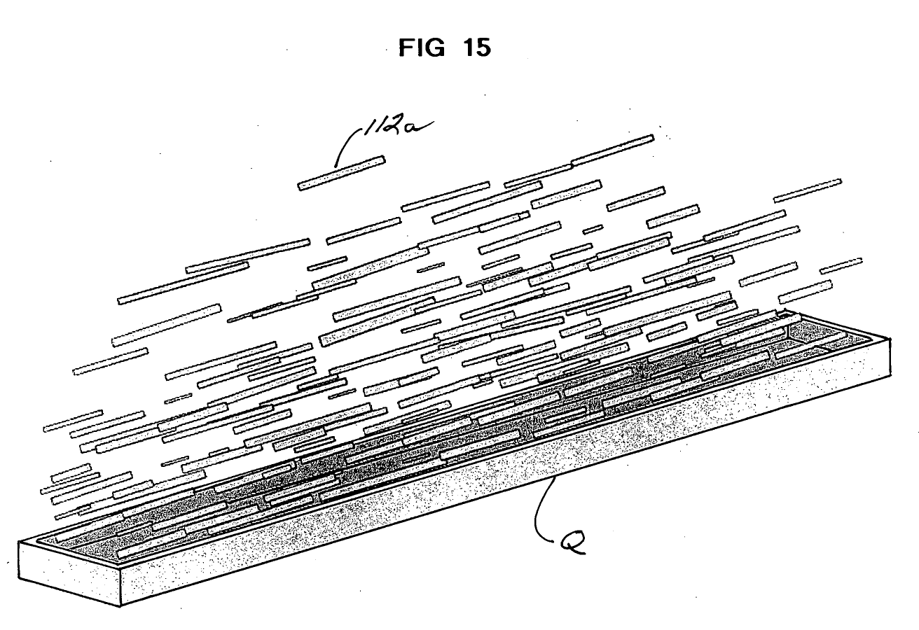

Referring now to FIG. 12, an alternate and preferred process for splitting a bamboo stalk 100 into half stalks 106 and 108 is there shown wherein a tapered splitter M is forced lengthwise along the entire stalk 100 as shown. The splitter M is wedge-shaped to facilitate the rapid splitting of the bamboo stalk 100. Each of the halves 106 (and 108 not shown) in FIG. 13 is fed through a series of rollers N in the direction of the arrow to produce a flattened slat 106a. The rollers accomplish the flattening, crosswise partial segmenting and dewatering of each of these bamboo halves in one continuous process. Then, in FIG. 14, strander P is forced lengthwise and across the width of each of the slats 106a in the direction of the arrow. The first strand removed also removes the exterior epidermis material, including nodes at 102a. Epidermis on the inner surface may be removed by machining or simply discarded with the last inner layer produced in FIG. 14. Note importantly that the flattening process of FIG. 13 has produced longitudinal breaks at 110 but not full separations therebetween. Thus, the natural fibers hold the slat 106a together until the stranding process shown in FIG. 14 is completed. At that time, the individual strands 112 are produced and ready for further processing and shortening into segments which shown in FIG. 15 at 12a, each having a thickness of about 1/16″, a width of about ½″ and a cut length of approximately 6″ to 12″ randomly occurring. Note further that the stranding process of FIG. 14 splits each segment 112 along natural fiber boundaries, rather than by machine or saw cutting, to avoid robbing material bamboo fiber strength from each segment.

After the stranding process shown in FIG. 14, the segments 112 are then further processed such as that shown in FIG. 6 as previously described treating the segments 112 for insect and parasite removal. Thereafter, in a process similar to that described in FIG. 7, the bamboo segments 112 are dried down to a moisture content of approximately 2% to 4% and then saturation loaded with resin preferably by soaking preferably in the form of phenol-formaldehyde available from Georgia Pacific Company typically used in PARALAM beams for about two hours. A second drying process of the resin-saturated strands is then accomplished to reduce the moisture content down to approximately 8% to 10%. After the consolidation of the resin-saturated and dried strands 112a into the frame Q shown in FIG. 15, the prepared strands 112a are compacted at a pressure of approximately 700 to 1000 psi at an elevated temperature of approximately 180° C. for approximately 60 minutes within the frame Q.

### Experimental Results

Test samples were prepared in accordance with the above preferred procedure by Forest Products Laboratories in Madison, Wis. The strands were soaked in pheno-formaldehyde resin for approximately 2 hours in a dilute resin bath. Pre-resin drying, and post-resin soak drying were accomplished as above described. Thereafter, the modulus of elasticity (pounds/in²) (MOE) was experimentally determined and compared to the MOE of Loblolly Pine and Pine Parallel Strandboard, the results of which are shown in Table I below.

TABLE I
Modulus of Elasticity

| Sample Type | MOE (lbs/in²) | Density lb/ft³ (PCF) |
|---|---|---|
| Southern Pine | 1.5 million | 39 |
| Glu-Lam | 1.8 million | 37 |
| Paral-Lam | 2.0 million | 41 |
| Bamboo-Lam | 3.4 million | 68 |

Note from Table I above that the bamboo specimen prepared in accordance with the teachings of the present invention had a MOE of approximately twice that of the Loblolly pine sample and approximately 50% greater MOE than that of the well-known commercially available STRANDBOARD manufactured by Weyerhaeuser Corporation.

### Plate Pressing Embedment Pressure Test

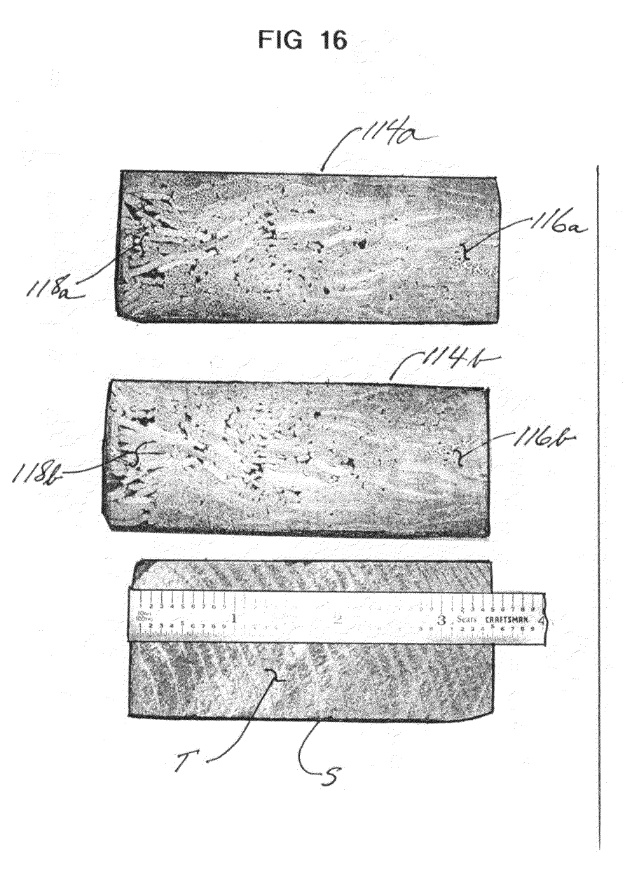

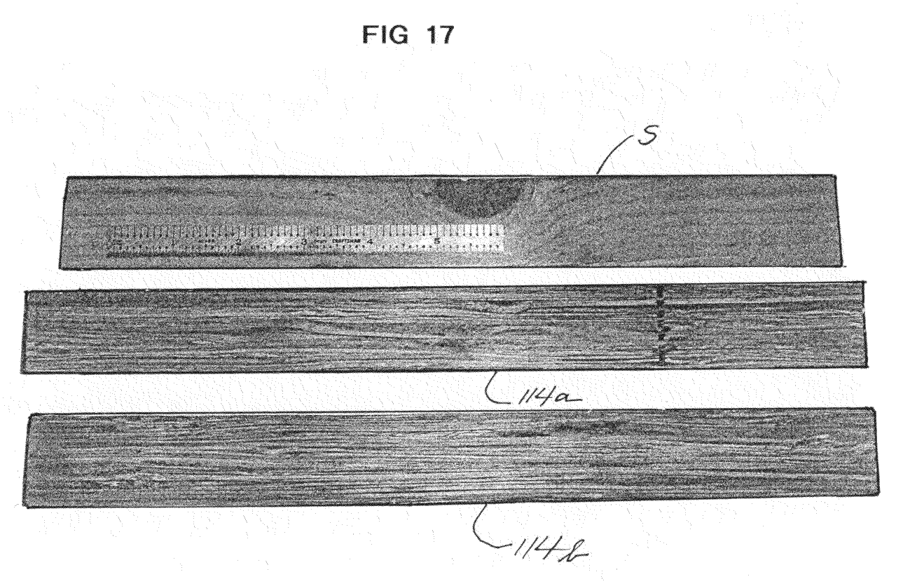

Referring to FIG. 16 to 19, this test, conducted by MITEK® from samples of the invention made by Forest Products Lab in Madison, Wis., involved pressing MT20 connectors into two bamboo test samples of material 114a and 114b, that measured 12⅝″×3½′″×1¼″. The samples resemble LSL type material with the following differences: The texture of wide face was different, one side is rough and the grain could be felt as seen in FIG. 17. Fibers of the material, and the opposite face was smooth. The density of the material changed across the width of the member as seen in FIG. 16. One edge 116a and 116b is very dense, and showed no voids or gaps when looking at the end. The opposite edge 118a and 118b had voids and gaps that existed between the segments of the material, reflective of a sample manufacturing defect.

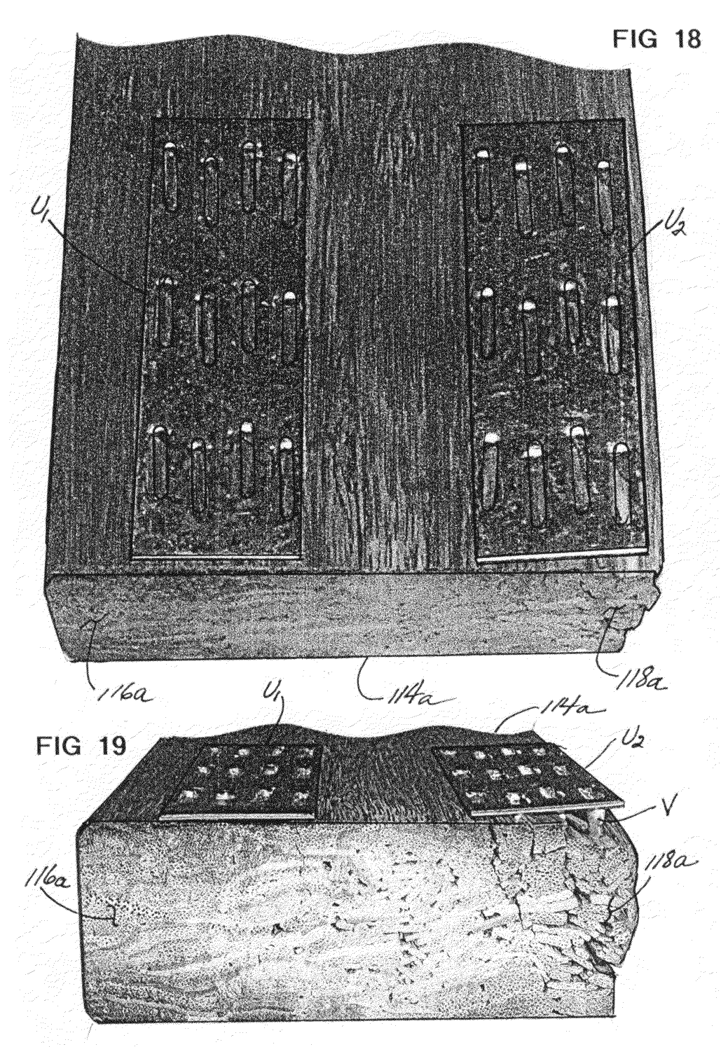

The MT20 1″×3″ connector plates U₁ and U₂ one at a time, were pressed into the wide face of the sample, adjacent to the edge of member 114a near one end as seen in FIGS. 18 and 19. One plate U₂ was pressed into the of the less dense edge 118a (the section with the most voids and gaps), and the other plate U₁ was pressed into the more dense edge 116a. The force required to press the plates into the samples was measured.

TABLE II

| | |
|---|---|
| Test Sample | Max Pressure (psi) to Embed |

Plate Pressing Embedment Pressure

| | |
|---|---|
| Bamboo beam - denser edge | 2966 |
| Bamboo beam - less dense edge | 915 |

For Comparison

| | |
|---|---|
| SPF | 856 |
| SYP | 1327 |
| TIMBERSTRAND | 1549 |

Although the bamboo test specimen appeared to incorporate a defect as above described along one edge of the test sample, nonetheless meaningful results may be drawn with respect to the plate pressed into the properly formed denser edge of the bamboo test specimen when compared to the same test performed on other conventional structural timber, namely SPF (spruce-pine-fir), SYP (spruce-yellow-pine) and TIMBERSTRAND. The data with respect to these conventional wooden structural members was taken from a test by MiTEK® owned by Berkshire & Hathaway, Inc.

This plate pressing embedment test clearly shows that the bamboo beam, when properly formed as along its denser edge in the test, is substantially denser than that of conventional wooden beams as reflected in nearly twice the pressure required for plate penetration when compared to TIMBERSTRAND, the otherwise highest reported timber test information available.

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent apparatus and articles.

1. A bamboo beam comprising:
a plurality of layers each formed of bamboo segments, each of said bamboo segments formed of dried and glue coated or dipped elongated bamboo strands which are substantially free of outer nodes and husk and inner membrane material prior to application of said glue, said segments, after the glue is applied, being re-dried to a maximum moisture content of about 10%, each said segment having a length, width and a longitudinal axis, said longitudinal axes of said segments in each of said layers being generally parallel to one another, said segments being compressed and bonded together to form a single integral structure.

2. A bamboo beam as set forth in claim 1, wherein:
said beam has a modulus of elasticity (MOE) of at least 3×10⁶ psi.

3. A bamboo beam as set forth in claim 1, wherein:
said beam has a modulus of elasticity (MOE) of at least twice that of a beam of similar size formed of southern pinewood.

4. A bamboo beam as set forth in claim 1, wherein:
said beam has a density of at least 60 lbs. per cubic foot (PCF)

5. A bamboo beam as set forth in claim 1, wherein:
said beam has a density of about twice that of a beam of similar size formed of southern pinewood.

6. A bamboo beam as set forth in claim 1, wherein:
said glue is a resin present in said beam in an amount of up to about 10% by volume.

7. A bamboo beam as set forth in claim 1, wherein:
said beam has a plate pressing embedment pressure strength of at least twice that of southern pine wood.

8. A bamboo beam as set forth in claim 1, wherein:
said bamboo strands are formed having substantially natural uncut fiber surfaces.

9. A bamboo beam as set forth in claim 1, wherein:
said segments are nominally sized in the range of 1/16″ thick, ½″. wide and 6 to 12″ long.

10. A process of forming a bamboo beam comprising the steps of:
splitting bamboo tubes lengthwise into halves;
flattening said halves into slats each having an outer and an inner surface;
planing each said surface of each of said slats to remove nodes and husk or epidermis from said outer surface of each said slat and inner membrane or epidermis material from said inner surface of each said slat;
stranding said slats into thin, flat elongated segments;
drying said segments to a moisture content of less than about 5%;
dipping said segments into a glue;
redrying said segments to a moisture content of less than about 10%;
arranging said segments into multiple layers within a frame, one said layer atop the next, each said layer having said segments oriented generally parallel to one another;
compressing said layers together within the frame while said glue cures into a single bonded integral structure.

11. A bamboo beam comprising a plurality of layers each formed of irregular bamboo segments, each of said bamboo segments formed of dried, segmented, and glue coated bamboo strands which are substantially free of outer nodes and husk and inner membrane material prior to application of said glue, each said segment having a length, width and a longitudinal axis, said longitudinal axes of said segments in each of said layers being generally parallel to one another, each said layer having said segments oriented generally orthogonally with respect to the next adjacent said layers thereto, said segments being compressed and bonded together to form a single integral structure, said beam made by the process comprising the steps of:
splitting bamboo tubes lengthwise into halves along natural bamboo fiber boundaries;
flattening said halves into slats each having an outer and an inner surface;
removing nodes and husk or epidermis from said outer surface of each said slat and inner membrane or epidermis material from said inner surface of each said slat;
stranding said slats along natural bamboo fiber boundaries into thin, flat elongated irregular segments;
drying said segments;
applying a glue coating to said segments;
arranging said segments into multiple layers, one said layer atop the next, each said layer having said segments oriented generally parallel to one another;
compressing said layers together while said glue cures into a single bonded integral structure.
